(19) United States
(12) Patent Application Publication
(10) Pub. No.: US 2016/0243751 A1
(43) Pub. Date: Aug. 25, 2016

(54) METHOD OF MANUFACTURING RESIN MOLDED PRODUCT AND MANUFACTURING DEVICE THEREOF

(71) Applicant: TOYOTA JIDOSHA KABUSHIKI KAISHA, Toyota-shi, Aichi-ken (JP)

(72) Inventors: Takafumi ANZAWA, Toyota-shi (JP); Teppei SUZUKI, Toyota-shi (JP)

(73) Assignee: TOYOTA JIDOSHA KABUSHIKI KAISHA, Toyota-shi, Aichi-ken (JP)

(21) Appl. No.: 15/030,623

(22) PCT Filed: Oct. 28, 2014
(86) PCT No.: PCT/IB2014/002236

§ 371 Date: Apr. 20, 2016

(30) Foreign Application Priority Data
Nov. 1, 2013 (JP) 2013-228746

(51) Int. Cl. B29C 51/42; B29C 51/08; B29C 51/30; B29C 47/00

(52) U.S. Cl. CPC B29C 51/428; B29C 47/0054; B29C 51/082; B29C 51/30; B29C 47/0019; B29L 2031/7172

(57) ABSTRACT

A manufacturing device of a resin fuel tank can efficiently cool molded bodies when a cooling mold is inserted on the inside of the sheet-like molded bodies and shaping molds are closed. Here, semispherical convex portions are tightly formed on a surface of the cooling mold, and a contact area of the convex portions with the molded body gradually decreases in a boundary region of the molded body in which transition from an contact portion, with which the cooling mold contacts, to a non-contact portion, with which the cooling mold does not contact, is made. Thus, a temperature gradient of the molded body is suppressed in the boundary region, and formation of a groove in the boundary region can be suppressed.

### BACKGROUND OF THE INVENTION

1. Field of the Invention

The present invention relates to a method of manufacturing a resin molded product and a manufacturing device thereof.

2. Description of Related Art

It is disclosed that, in order to produce a large-sized hollow resin molded product by hollow molding, a three-dimensional cooling mold is inserted in a molten resin, which is extruded from an extrusion die, shaping molds are closed, and the molten resin is thereby cooled by both of the shaping molds and the cooling mold (see Japanese Patent Application Publication No. 2012-218212 (JP 2012-218212 A), for example). This can shorten a cooling time and thus to shorten a molding cycle.

When the inside of the molten resin is cooled by the cooling mold, just as described, a groove may be formed by a difference in an amount of thermal contraction caused by a temperature difference in a boundary region between an contact portion of the resin mold that contacts the cooling mold and a non-contact portion thereof that does not contact the cooling mold.

In addition, when a molded product is formed of a multi-layer resin, a layer structure may be disturbed in this groove portion.

### SUMMARY OF THE INVENTION

The present invention provides a method of manufacturing a resin molded product and a manufacturing device thereof that can mold the resin molded product accurately.

A method of manufacturing a resin molded product according to one aspect of the present invention includes: extruding a molten resin from an extrusion die; and bringing a cooling mold, which is formed with plural convex portions at a position on a surface facing a shaping mold, into contact with the molten resin after shaping the molten resin by a shaping mold or at the same time as shaping the molten resin by the shaping mold, the cooling mold holding the molten metal, and a projection height of the convex portion being lower than a thickness of the shaped molten resin.

According to this method of manufacturing the resin molded product, the molten resin, which is extruded from the extrusion die, is shaped by the shaping mold. The cooling mold contacts a position in the molten resin that is opposite from the shaping mold after shaping or at the same time as shaping, and thus the molten resin can efficiently be cooled. At this time, since the convex portion, which is formed on the surface of the cooling mold, cuts into the molten resin, an amount of the cut (a contact area) of the convex portion with respect to the molten resin gradually decreases in a boundary region between a contact portion where the cooling mold contacts the molten resin and a non-contact portion where the cooling mold does not contact the molten resin. In other words, since a degree of cooling of the molten resin in the boundary region is gradually changed, a temperature gradient in the boundary region is suppressed. As a result, the formation of a groove in the boundary region, which is caused by a difference in an amount of thermal contraction, can be suppressed. In addition, since the projection height of the convex portion is lower than the thickness of the shaped molten resin, there is no possibility that the convex portion cuts through the molten resin. Optionally, shaping the molten resin by the shaping mold includes holding the molten resin between the cooling mold and the shaping mold. In this case, <<at the same time as shaping>> includes shaping the molten resin by holding the molten resin between the cooling mold and the shaping mold.

In the method of manufacturing the resin molded product, when the molten resin is extruded from the extrusion die, the molten resin may be extruded in a sheet shape.

According to this method of manufacturing the resin molded product, the cooling mold contacts the side of the sheet-like molten resin that is opposite from the shaping mold, the sheet-like molten resin having been extruded from the extrusion die. Thus, compared to a cylindrical molten resin, the cooling mold can easily contact the sheet-like molten resin.

In the method of manufacturing the resin molded product, the convex portion may be in a curved surface shape.

According to this method of manufacturing the resin molded product, when the cooling mold contacts the molten resin, the convex portion, which is formed on the surface of the cooling mold, cuts into the molten resin. Thus, a surface of the resin molded product is formed with a concave portion that corresponds to the convex portion. If the convex portion has a shape with corners, stress may be concentrated on corners of the concave portion, which is formed in the molded product. However, since the convex portion is in a curved surface shape, it is possible to suppress the stress concentration on the concave portion of the molded product, which is formed by the convex portion.

In the method of manufacturing the resin molded product, the convex portion may be semispherical.

In the method of manufacturing the resin molded product, the convex portions may tightly be formed in a portion of the cooling mold that contacts the molten resin when the cooling mold contacts the molten resin.

According to this method of manufacturing the resin molded product, the convex portion of the cooling mold is necessary in a boundary region between an contact portion of the molten resin, with which the cooling mold contacts, and a non-contact portion, with which the cooling mold does not contact. This boundary region is generated at a position that is intended by design due to the shape or the like of the cooling mold, and is also generated at an unintended position due to the uneven thickness of the molten resin or the like. Thus, when the cooling mold contacts the molten resin and the convex portions are tightly formed in the portion of the cooling mold that contacts the molten resin. the convex portion also contacts the boundary region of the molten resin that is generated at the unintended position. Therefore, it is possible to reduce the temperature gradient in the boundary region of the molten resin and thus to suppress generation of the groove in the resin molded product.

In the method of manufacturing the resin molded product, a temperature of the cooling mold may be adjustable by a temperature adjustment portion.

According to this method of manufacturing the resin molded product, since the cooling mold has the temperature adjustment portion, it is possible to adjust a cooling temperature during cooling of the molten resin. Accordingly, a contact (a cooling) time of the cooling mold with respect to the molten resin is extended by setting a minimum temperature required for the cooling of the resin. This can increase a cooling effect on the resin with low thermal conductivity. Particularly, it is effective when a thick molten resin is cooled.

In the method of manufacturing the resin molded product, the temperature adjustment portion may be a conduit that is formed in the cooling mold and through which a cooling liquid or gas flows.

According to this method of manufacturing the resin molded product, since the temperature adjustment portion is the conduit that is provided in the cooling mold and through which the cooling liquid or gas flows, it is possible to easily control the temperature of the cooling mold by setting the flow of the liquid or gas, the temperature of which is adjusted.

In the method of manufacturing the resin molded product, the resin molded product may be a part of a fuel tank for a vehicle, the fuel tank being made of the resin.

According to this method of manufacturing the resin molded product, it is possible to suppress the formation of the groove in the boundary region between the contact portion and the non-contact portion of the molten resin with respect to the cooling mold. As a result, specified strength can be secured for the fuel tank, the fuel tank being made of the resin or a part thereof, as the molded product.

A manufacturing device of the resin molded product includes: the extrusion die extruding the molten resin; the shaping mold shaping the molten resin; and the cooling mold cooling the molten resin when the cooling mold contacts the molten resin at the position where the shaping mold and the cooling mold face each other, the shaping mold and the cooling mold holding the molten resin between the shaping mold and the cooling mold, the plural convex portions being formed at the position where the cooling mold and the shaping mold face each other and the plural convex portions being formed on the surface of the cooling mold, and the projection height of the convex portion being lower than the thickness of the shaped molten resin.

According to this manufacturing device of the resin molded product, the molten resin, which has been extruded from the extrusion die, is shaped by the shaping mold, and the cooling mold contacts the molten resin at the position that is opposite from the shaping mold. Thus, the molten resin is efficiently cooled. At this time, since the convex portion, which is formed on the surface of the cooling mold, cuts into the molten resin, the amount of the cut (the contact area) of the convex portion with respect to the molten resin gradually decreases in the boundary region between the contact portion where the cooling mold contacts the molten resin and the non-contact portion where the cooling mold does not contact the molten resin. In other word, since a degree of cooling of the molten resin in the boundary region is gradually changed, the temperature gradient in the boundary region is suppressed. As a result, the formation of the groove in the boundary region, which is caused by the difference in the amount of the thermal contraction, can be suppressed. In addition, since the projection height of the convex portion is lower than the thickness of the shaped molten resin, there is no possibility that the convex portion cuts through the molten resin.

As described above in detail, according to the present invention, the resin molded product can accurately be manufactured.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an overall configuration view of a manufacturing device of a resin fuel tank according to one embodiment of the present invention;

FIG. 2A is a process drawing of a method of manufacturing the resin fuel tank according to the embodiment of the present invention;

FIG. 2B is a process drawing of the method of manufacturing the resin fuel tank according to the embodiment of the present invention;

FIG. 2C is a process drawing of the method of manufacturing the resin fuel tank according to the embodiment of the present invention;

FIG. 3A is a process drawing of the method of manufacturing the resin fuel tank according to the embodiment of the present invention;

FIG. 3B is a process drawing of the method of manufacturing the resin fuel tank according to the embodiment of the present invention;

FIG. 3C is a process drawing of the method of manufacturing the resin fuel tank according to the embodiment of the present invention;

FIG. 4 is an enlarged view of main components of the manufacturing device of the resin fuel tank according to the embodiment of the present invention; and

FIG. 5 is a view for illustrating an advantage of the method of manufacturing the resin fuel tank according to the embodiment of the present invention.

### DETAILED DESCRIPTION OF EMBODIMENTS

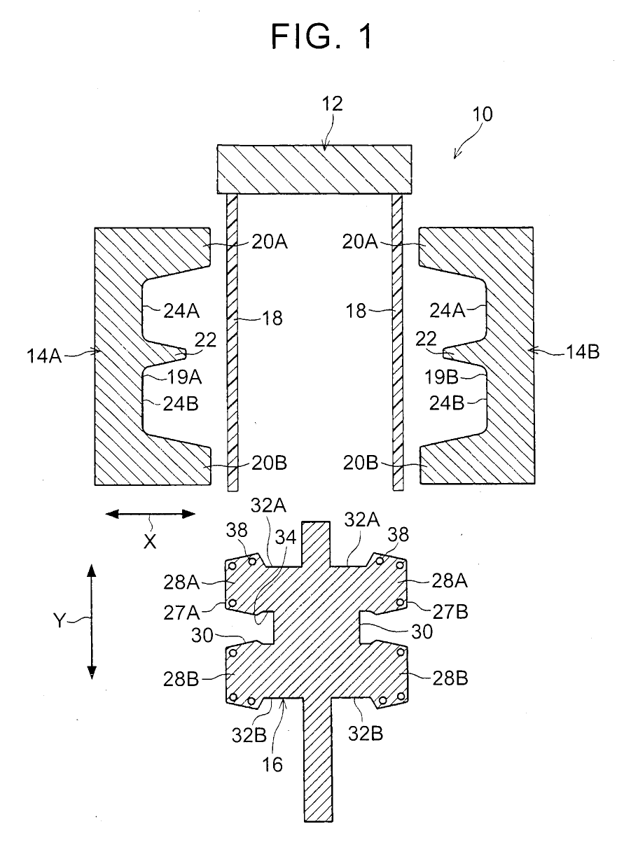

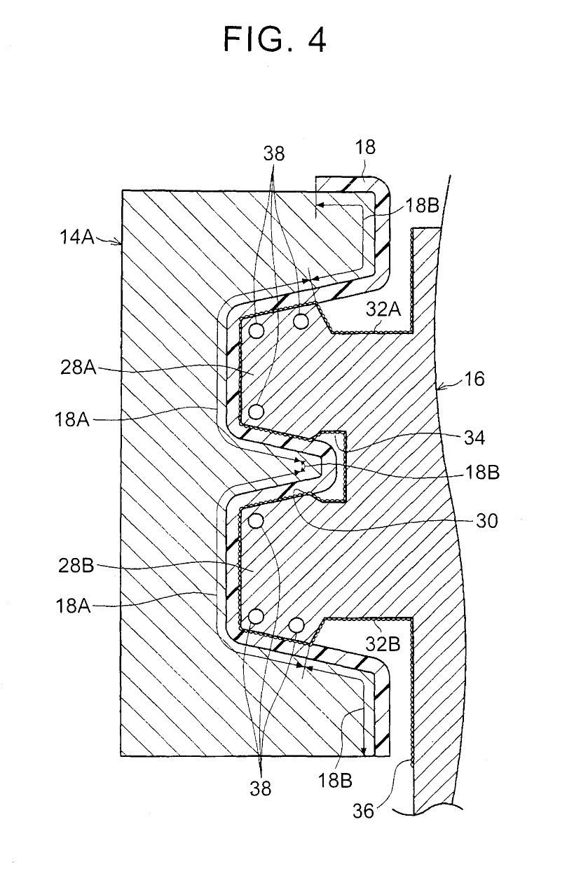

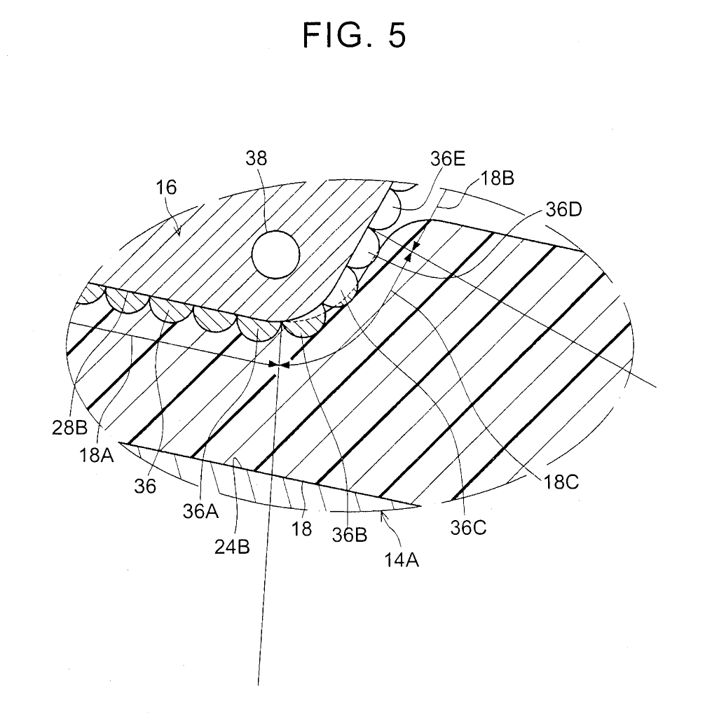

A description will be made on a method of manufacturing a resin molded product and a manufacturing device thereof according to one embodiment of the present invention with reference to FIG. 1 to FIG. 5. In FIG. 4 and FIG. 5, some portions are shown in an exaggerated manner for convenience of the description.

In this embodiment, a description will be made on a case of a fuel tank for a vehicle, the fuel tank being made of a resin (hereinafter referred to as a “resin fuel tank”) as an example of the resin molded product. First, a manufacturing device of the resin fuel tank will be described. Then, a method of manufacturing thereof will be described.

As shown in FIG. 1, a manufacturing device of the resin fuel tank (hereinafter referred to as a “manufacturing device”) 10 includes: a die head 12 that extrudes a sheet-like molten resin; a pair of shaping molds 14A, 14B that shapes the sheet-like molten resin, which has been extruded from the die head 12; and a cooling mold 16 that enters the inside of the pair of shaping molds 14A, 14B to cool the sheet-like molten resin from the inside.

The die head 12 is a well-known extrusion head and supplies a sheet body of the molten resin in specified width and thickness (hereinafter referred to as a “molded body”) 18 to a space between the pair of shaping molds 14A, 14B.

The pair of shaping molds 14A, 14B is configured such that they can approach and separate from each other in an arrow X direction, that is, the molds can be opened and closed. Two concave portions 24A, 24B, each of which corresponds to a shape of the resin fuel tank and sandwiches a convex portion 22 between frame portions 20A, 20B, are respectively formed in inner surfaces 19A, 19B of the shaping molds 14A, 14B.

As shown in FIG. 1, the cooling mold 16 is configured that it can freely advance and retract in the space between the shaping molds 14A, 14B in an arrow Y direction that is orthogonal to the arrow X direction. Convex portions 28A, 28B, which respectively correspond to the concave portions 24A, 24B of the shaping molds 14A, 14B during advancement, and a concave portion 30, which corresponds to the convex portion 22 during advancement, are formed in outer surfaces 27A, 27B that respectively face the inner surfaces 19A, 19B of the shaping molds 14A, 14B.

As shown in FIG. 4, the convex portions 28A, 28B of the cooling mold 16 are respectively formed with a concave portion 32A and a concave portion 32B in root portions. In addition, the concave portion 30 of the cooling mold 16 is formed with a widened portion 34 in an inner side.

Furthermore, as shown in FIG. 4, semispherical convex portions 36 are formed tightly and uninterruptedly for an entire surface of each of the outer surfaces 27A, 27B in the cooling mold 16 (see FIG. 5). Here, a phrase “formed tightly” means that the adjacent convex portions 36 are formed such that an interval thereof is shorter than a diameter of a bottom surface thereof (a maximum length). In this embodiment, lower ends of the adjacent convex portions 36 contact each other. In addition, a height of the convex portion 36 is set such that a projection height thereof is lower than a thickness of the molded body (the molten resin) 18, which has been shaped.

Moreover, a conduit 38 for cooling water is formed in the cooling mold 16. It is configured that the molded body 18, with which the convex portions 28A, 28B contact, is cooled by circulating the cooling water, a temperature of which is adjusted.

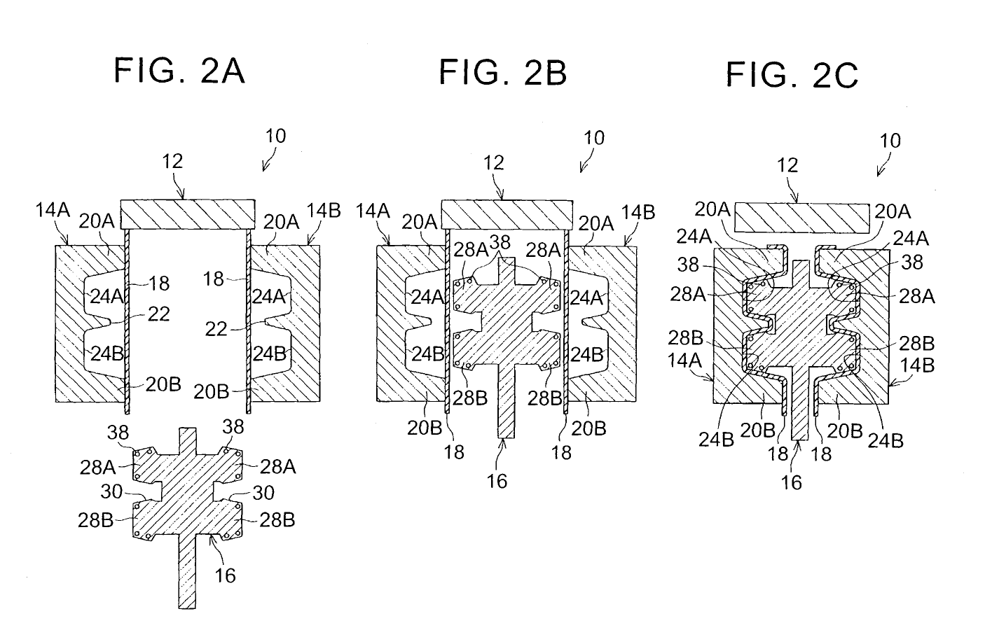

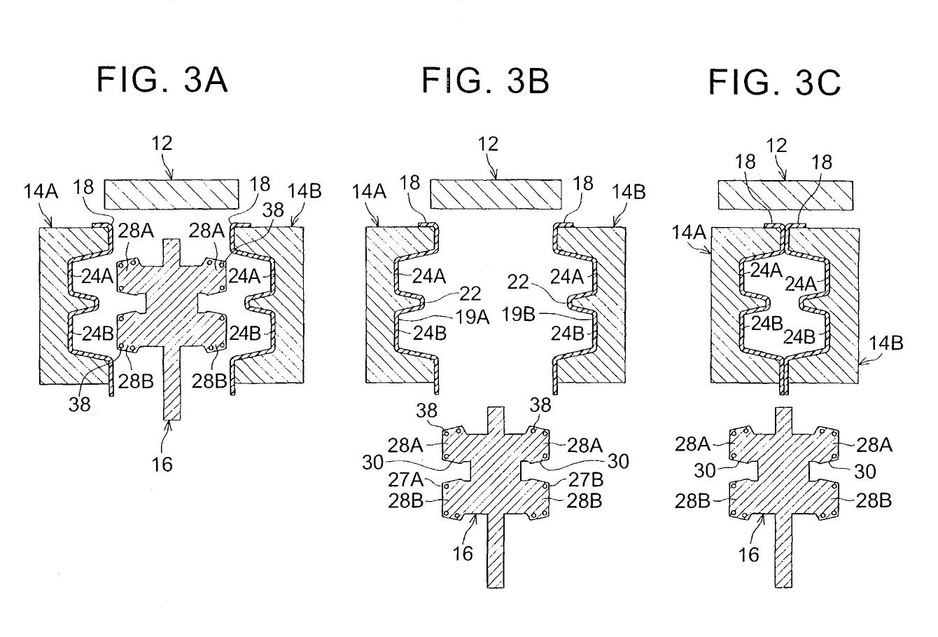

A description will be made on a method of manufacturing the resin fuel tank by using the thus-configured manufacturing device 10 with reference to FIG. 2 and FIG. 3.

First, a pair of the sheet-shaped molded bodies 18 is supplied from the die head 12 to the space between the opened shaping molds 14A, 14B (see FIG. 2A).

Next, the cooling mold 16 is inserted in the space between the shaping molds 14A, 14B (see FIG. 2B).

Then, when the shaping molds 14A, 14B are closed, the molded bodies 18 are pressed against the concave portions 24A, 24B and the convex portion 22 of the shaping molds 14A, 14B by the convex portions 28A, 28B and the concave portion 30 of the cooling mold 16, and the molded bodies 18 are shaped along the inner surfaces 19A, 19B of the shaping molds 14A, 14B (see FIG. 2C).

At the same time, the paired molded bodies 18 that are shaped by the shaping molds 14A, 14B are cooled by being contacted with the convex portions 28A, 28B of the cooling mold 16 on opposite surfaces from the shaping molds 14A, 14B, that is, from the inside. Particularly, since the cooling water, the temperature of which is adjusted, is circulated in the conduits 38 of the convex portions 28A, 28B, the molded bodies 18, each of which is the molten resin, are effectively cooled.

After the molded bodies 18 are cooled, the shaping molds 14A, 14B are opened (see FIG. 3A). Next, the cooling mold 16 is lowered (drawn out) from the space between the shaping molds 14A, 14B (see FIG. 3B).

Then, the shaping molds 14A, 14B are closed, and the air is filled on the inside of the molded bodies 18 for hollow molding of the resin fuel tank (see FIG. 3C).

FIG. 4 shows a partial enlarged view during cooling of the molded bodies 18, which is shown in FIG. 2C, in a manufacturing process of the resin fuel tank as described above. As shown in FIG. 4, the molded body 18 is divided into contact portions 18A, with which the convex portions 28A, 28B of the cooling mold 16 contact, and non-contact portions 18B, with which the concave portions 32A, 32B and the widened portion 34 of the concave portion 30 in the cooling mold 16 do not contact.

FIG. 5 shows an enlarged view for illustrating a boundary region between the contact portion 18A and the non-contact portion 18B of the molded body 18 in detail. As shown in FIG. 5, in a boundary region 18C between the contact portion 18A, in which (the convex portion 28B of) the cooling mold 16 contacts the molded body 18, and the non-contact portion 18B, from which (the concave portion 32B of) the cooling mold 16 separates, the molded body 18, the contact portion 18A of which is held between the shaping mold 14A and the cooling mold 16, is released, and a thickness of the molded body 18 thereby increases.

The contact portion 18A of the molded body 18 contacts the almost entire surfaces of the convex portions 36 in the cooling mold 16. Meanwhile, in the boundary region 18C where transition from the contact portion 18A to the non-contact portion 18B is made, as shown in FIG. 5, an area of the molded body 18 that contacts the convex portions 36 (hatched portions in the convex portions 36B to 36D in FIG. 5) gradually decreases with the transition to the non-contact portion 18B. Then, the non-contact portion 18B does not contact a convex portion 36E at all.

Thus, in the boundary region 18C, the surface area of the convex portions 36 that contact the molded body 18 gradually decreases from the contact portion 18A toward the non-contact portion 18B. As a result, a temperature of the molded body 18 gradually increases from the contact portion 18A to the non-contact portion 18B. In other words, a temperature gradient is suppressed in the boundary region 18C of the molded body 18. Accordingly, since the temperature of the molded body 18 varies abruptly at the boundary region 18C, formation of a groove, which causes stress concentration, in the boundary region 18C due to a difference in an amount of thermal contraction is suppressed.

In addition, since the formation of the groove in the molded body 18 is suppressed, disturbance of a layer structure of the fuel tank that is formed of the multi-layer resin is also suppressed. That is, the fuel tank can be molded accurately.

Furthermore, since the surface shape of the convex portion 36 is semispherical (a curved surface), the surface of the sheet-like molded body 18 is not formed with a square concave portion. In other words, the concave portion with corners, which causes the stress concentration, is suppressed from being formed on the surface of the molded body 18, which becomes the fuel tank, by the convex portion 36.

Moreover, the convex portions 36 are tightly formed for the entire surfaces of the outer surfaces 27A, 27B in the cooling mold 16. Thus, even in the case where the boundary region 18C between the contact portion 18A and the non-contact portion 18B is formed at any position in the molded body 18, for example, even in the case where the boundary region 18C between the contact portion 18A and the non-contact portion 18B is generated at an unintended position due to the uneven thickness of the molded body 18, the convex portions 36 reliably contacts a portion in the vicinity of the boundary region in the molded body 18. Therefore, it is possible to reliably suppress an abrupt temperature change in the vicinity of the boundary region in the molded body 18.

In this embodiment, since the sheet-like the molded bodies 18 are used to mold the fuel tank, the cooling mold 16 can easily be inserted on the opposite sides of the shaping molds 14A, 14B with the molded bodies 18 being interposed therebetween. In other words, in case of a cylindrical molded body, the insertion of the cooling mold 16 is troublesome. However, in case of this embodiment, the cooling mold 16 can easily be inserted by adjusting a distance between the sheet-like molded bodies 18.

The cooling mold 16 is adapted that the temperature thereof can be adjusted due to circulation of the cooling water, the temperature of which is adjusted, through the conduit 38. Thus, when a resin with low thermal conductivity is used as in this embodiment, the cooling mold 16 is set at a minimal temperature for the cooling, and a time during which the cooling mold 16 contacts the molded body 18 is extended. Accordingly, a high cooling effect can be exerted. Especially, when the molded body 18 is thick, the low thermal conductivity thereof becomes problematic. However, the high cooling effect can be obtained by cooling the molded body 18 as described above.

On the other hand, when the molded body 18 is thin, the specified cooling effect can be obtained by setting the temperature of the cooling mold 16 to be low. Thus, a molding cycle can be shortened by setting the temperature of the cooling mold 16 to be low.

In this embodiment, the molded bodies 18 are held between the cooling mold 16 and the shaping molds 14A, 14B and are thereby shaped by the shaping molds 14A, 14B. However, the present invention is not limited thereto. For example, as shown in FIG. 2A, a configuration may be adopted in which the molded bodies 18, which are inserted between the opened shaping molds 14A, 14B, may be suctioned to the concave portions 24A, 24B sides by an unillustrated vacuum portion, so as to be shaped by the shaping molds 14A, 14B. Alternatively, instead of the vacuum suction, a configuration may be adopted in which the molded bodies 18 are shaped from the opposite sides by the shaping molds 14A, 14B with pressure. When such a configuration is adopted, the molded bodies 18 are shaped by the shaping molds 14A, 14B before the insertion of the cooling mold 16. In addition, in this embodiment, the molds are closed, and the air is filled on the inside of the molded bodies 18 for the hollow molding in the final process (see FIG. 3C). However, the configuration of this embodiment can also be adopted to mold an impeller, for example, simply by vacuuming the sheet-like molded body 18, shaping the molded body 18 by the shaping mold 14A, and contacting the cooling mold 16 with the molded body 18.

In addition, in this embodiment, the convex portion 36 has the semispherical shape. However, the shape of the convex portion 36 is not particularly limited thereto. For example, the convex portion 36 may be in a shape of a cylinder, a triangular pyramid, or the like. However, in case of a shape with a pointed tip, such as the triangular pyramid, the molded body 18 is formed with the pointed concave portion, which may result in the stress concentration. Thus, a curved surface shape is preferred.

Furthermore, in this embodiment, the convex portions 36 are tightly formed for the entire surfaces of the outer surfaces 27A, 27B of the cooling mold 16. However, the configuration is not limited thereto. For example, as long as the temperature gradient can be suppressed to such a degree that the formation of the groove is prevented, the convex portions 36 may be formed at specified intervals. In addition, instead of being provided in the entire surfaces of the outer surfaces 27A, 27B, the convex portions 36 may be provided locally. For example, it is considered to provide the convex portions 36 locally in a portion where the boundary region 18C between the contact portion 18A and the non-contact portion 18B is formed. It is also considered that the convex portions 36 can handle an unintended boundary region as long as they are formed on the outer surfaces 27A, 27B of the cooling mold 16, which correspond to the contact portion 18A and the boundary region 18C in this embodiment.

Moreover, the sheet-like molten resin, which is extruded from the die head 12 of this embodiment, may be formed by extruding the sheet-like molten resin, may be formed in the sheet shape by cutting and opening a cylindrical molten resin, or may be formed in the sheet shape by splitting flows in the die head 12. In this embodiment, the cooling water is circulated through the conduit 38 of the cooling mold 16. However, another type of liquid may be adopted. Alternatively, gas such as the air may be adopted. A temperature adjustment portion of the cooling mold 16 is not limited to such a conduit, but may be a heater or the like.

In this embodiment, the method of manufacturing the resin fuel tank as the resin molded product and the manufacturing device thereof have been described. However, the resin molded product is not limited to the resin fuel tank. The present invention can be applied to a method of manufacturing another resin molded product and a manufacturing device thereof.

1. A method of manufacturing a resin molded product comprising:
extruding a molten resin from an extrusion die; and
bringing a cooling mold into contact with the molten resin after shaping the molten resin by a shaping mold or at the same time as shaping the molten resin by the shaping mold, the shaping mold and the cooling mold holding the molten resin between the shaping mold and the cooling mold, plural convex portions being formed at a position where the cooling mold and the shaping mold face each other and the plural convex portions being formed on a surface of the cooling mold, and a projection height of the convex portion being lower than a thickness of the shaped molten resin.

2. The method of manufacturing the resin molded product according to claim 1, wherein
at the same time as shaping the molten resin by the shaping mold includes a case of shaping the molten resin by holding the molten resin between the cooling mold and the shaping mold.

3. The method of manufacturing the resin molded product according to claim 1, wherein
the molten resin is extruded in a sheet shape when the molten resin is extruded from the extrusion die.

4. The method of manufacturing the resin molded product according to claim 1, wherein
the convex portion is in a curved surface shape.

5. The method of manufacturing the resin molded product according to claim 4, wherein
the convex portion is in a semispherical shape.

6. The method of manufacturing the resin molded product according to claim 1, wherein
the convex portions are tightly formed in a portion of the cooling mold, in which the cooling mold contacts the molten resin when the cooling mold contacts the shaping mold.

7. The method of manufacturing the resin molded product according to claim 1, wherein
a temperature of the cooling mold is adjusted by a temperature adjustment portion when the cooling mold contacts t the shaping mold.

8. The method of manufacturing the resin molded product according to claim 7, wherein
the temperature adjustment portion is a conduit, which is formed in the cooling mold and through which a cooling liquid or gas flows.

9. The method of manufacturing the resin molded product according to claim 1, wherein
the resin molded product is a part of a fuel tank for a vehicle, the fuel tank being formed of a resin.

10. A manufacturing device of a resin molded product comprising:
an extrusion die extruding a molten resin;
a shaping mold shaping the molten resin;
a cooling mold cooling the molten resin when the cooling mold contacts the molten resin at a position where the shaping mold and the cooling mold face each other, the shaping mold and the cooling mold holding the molten resin between the shaping mold and the cooling mold, plural convex portions being formed at the position where the shaping mold and the cooling mold face each other and the plural convex portions being formed on a surface of the cooling mold, and a projection height of the convex portion being lower than a thickness of the shaped molten resin.
